(19) United States
(12) Patent Application Publication
(10) Pub. No.: US 2005/0058226 A1
(43) Pub. Date: Mar. 17, 2005

(54) Demodulation of a frequency modulated received signal by means of two-stage path selection in a trellis diagram

(76) Inventors: Jurgen Niederholz, Kerken (DE); Andre Neubauer, Krefeld (DE)

Correspondence Address: Andreas Grubert;Baker Botts L.L.P., 910 Louisiana, One Shell Plaza, Houston, TX, 77002-4995, US

(21) Appl. No.: 10/938,240

(22) Filed: Sep. 10, 2004

(30) Foreign Application Priority Data
Sep. 12, 2003 (DE) 103 42 361.3

(51) Int. Cl. H04L 27/06

(52) U.S. Cl. 375/323; 375/341

(57) ABSTRACT

The possible number of zero crossings in the interval [kT_{b},(k+1)T_{b}] is determined for each time (k+1)T_{b} based on hypothetical subsequences, on the basis of a model for frequency modulation, and a trellis diagram is constructed, based on the model. In a first selection step, those paths in the trellis diagram are then excluded whose number of zero crossings in the stated interval does not match the number of detected zero crossings in the received subsequence in this interval. In a second selection step, the path metrics of the paths which still exist are extended by the new branch metrics based on the Viterbi algorithm which is known per se. If two paths meet one another at a node point then only that path which has the lower path metric is continued.

### PRIORITY

This application claims priority to German application no. 103 42 361.3 filed Sep. 12, 2003.

### TECHNICAL FIELD OF THE INVENTION

The present invention relates to a method and an apparatus for demodulation of a received signal which is transmitted by radio and which was digitally frequency modulated at the transmitter end with a data symbol sequence.

### BACKGROUND OF THE INVENTION

The method and the apparatus to which the invention relate are preferably components of cordless digital communications systems which are based on the Bluetooth, DECT or WDCT Standard or on some similar standard.

In communications systems such as these, traditional signal processing methods are used at the receiver end for signal detection and for demodulation of the frequency modulated received signal. One method which is often used is based on the so-called linear discriminator FM demodulator, in which, after hard limiting of the generally complex bandpass signal the frequency modulated signal is demodulated, for example by means of an analogue coincidence demodulator, with corresponding signal detection.

Furthermore, receiver concepts are known in which the intermediate frequency signal is converted with the aid of an analogue/digital converter to the digital form, and the signal detection is carried out using digital signal processing methods. One such method is described, by way of example, in the document DE 101 03 479.3. Methods such as these admittedly allow high-quality signal detection to be achieved, but they have the disadvantage that the analogue/digital converter is complex.

German Patent Application DE 102 14 581.4, which represents the prior art, in accordance with § 3, Clause 2 of the German Patent Act, describes a demodulation method for a digitally frequency modulated analogue received signal in a cordless communications system, in which the time intervals between the zero crossings of the received signal or of an intermediate frequency signal which is produced from the received signal are determined and are used for detection of the digital signal data. The data symbols (dₖ) in a CPFSK-modulated (Continuous Phase Frequency Shift Keying) signal are detected by splitting the data symbol sequence into subsections, which contain two or more zero crossings and whose length may cover two or more symbol intervals. The sequence of zero crossing intervals can be stored in digital form, in a shift register chain, and can be compared in a classification device with previously stored interval sequences, with a city block metric being proposed for measuring the distance between the measured sequences and the stored sequences. That previously stored pattern sequence which has the shortest distance from the measured sequence is interpreted as the transmitted pattern. The data sequence which corresponds to this selected pattern represents the detected data sequence, and thus the solution to the detection problem.

In the demodulation method which is described in German Patent Application DE 102 37 867.3, which likewise forms the prior art in accordance with § 3, Clause 2 of the German Patent Act, a sequence of determined zero crossing intervals in the received signal is used to reconstruct the data symbol sequence by selecting from the possible data symbol sequences that the sought data symbol sequence for which the Euclidean distance between the sequence of zero crossing intervals and the sequence as calculated at the receiver end is a minimum. A model which can be represented as a filter for the frequency modulation is applied at the receiver end to all the theoretically feasible data symbol sequences, with each sequence element in the calculated sequence being calculated from convolution of the data symbol sequence with a filter coefficient sequence. During the reconstruction process, a Viterbi algorithm which has been suitably extended by a reactive component is used in the trellis diagram constructed on the basis of the model (Reactive Viterbi Algorithm). In this case, when calculating the branch metric, the varying number of zero crossings is taken into account so that the entire received sequence (instead of only sequence elements) is assessed. The disadvantage in this case is that an inherent assumption must be made about the transmitted data for the calculation of the branch metrics. This leads to an additive error component in the branch metric.

German Patent Application DE 103 00 267.7, which likewise represents the prior art in accordance with § 3, Clause 2 of the German Patent Act, describes a demodulation method in which the number of zero crossings, which varies in each symbol interval, is mapped by means of a non-linear rule on to a number of parameter values, which is constant in each symbol interval. The transmitted data symbol sequence is then reconstructed from the sequence of parameter values by means of a suitable detection algorithm, such as Viterbi detection. This method has the disadvantage, however, that the mapping is generally at the expense of a loss of information.

### SUMMARY OF THE INVENTION

The object of the present invention is thus to specify a method and an apparatus for demodulation of a digitally frequency modulated received signal, which allows high performance to be achieved with acceptable implementation complexity.

This object can be achieved by a method for demodulation of an analogue received signal which is digitally frequency modulated at the transmitter end with a data symbol sequence, comprising the steps of:

a) detecting zero crossings in the received signal,

b) calculating zero crossing sequences of subsequences of the data symbol sequence with a model for frequency modulation with memory,

c) constructing a trellis diagram on the basis of the model for the frequency modulation with memory,

d) reconstructing the transmitted data symbol sequence, wherein for each time and throughout the duration of a received subsequence:
d.1) those paths through the trellis diagram are excluded whose state with respect to an interval corresponds to a number of hypothetical zero crossings, which number does not match the number of detected zero crossings of the received signal in the interval and then
d.2) the branch metrics of the remaining paths are calculated and are added to the respective existing path metrics, wherein, when two paths meet one another at a node point in the trellis diagram, the path with the lower path metric is selected.

In method step b), data symbols from the hypothetical subsequences can be fed into a filter, in which the zero crossing sequences are calculated on the basis of the model. The filter can be a linear state machine. Before carrying out the method steps, the transmitter which is transmitting the frequency-modulated signal and the receiver which is receiving the frequency-modulated signal can be synchronized to one another. The frequency-modulated received signal can be a Continuous Phase Frequency Shift Keying signal (CPFSK).

The object can also be achieved by an apparatus for demodulation of an analogue received signal which is digitally frequency modulated at the transmitter end with a data symbol sequence, comprising a detector for detecting zero crossings in the received signal, a sequence detector for the formation of hypothetical subsequences of the data symbol sequence, and a comparison and calculation unit for calculation of zero crossing sequences corresponding to the model of a frequency modulation group with memory, for comparison of the numbers of calculated and detected zero crossings, and for calculation of branch metrics of paths, and for their addition to respective existing path metrics once paths have previously been excluded on the basis of the comparison of the numbers of zero crossings.

The comparison and calculation unit may comprise a filter for calculation of the zero crossing sequences on the basis of the model. The filter can be a linear state machine. The zero crossing detector can be formed by a limiter/discriminator apparatus, or contains such an apparatus. The apparatus can be designed for Continuous Phase Frequency Shift Keying signals (CPFSK). The apparatus can be implemented in a cordless digital communications system which is based, in particular, on the Bluetooth or DECT or WDCT Standard.

The method according to the invention is based on the idea that the transmitter-end frequency modulation of the signal to be transmitted has a memory, and that a model can be constructed for the modulation memory of the transmitter-end frequency modulation. A trellis diagram is constructed on the basis of this model for the frequency modulation with memory. Subsequences of the transmitted data symbol sequence are reconstructed by means of the trellis diagram.

First of all, all of the theoretically feasible hypothetical subsequences are calculated, the model is applied to these subsequences, and the hypothetical zero crossing sequences which correspond to the subsequences are determined from them.

Two selection steps are then carried out successively in the trellis diagram. In a first selection step, those paths are excluded whose number of zero crossings in a specific interval does not match the number of zero crossings in the received sequence in this interval. In a second selection step, the path metrics of the paths which still exist are extended by the new branch metrics. These are obtained from the comparison of received zero crossings, with hypothetical zero crossings in the relevant interval. If two paths meet one another at a node point in the trellis diagram, then only that path with the lower path metric is continued.

In detail, the method according to the invention thus has the following steps:

a) detection of zero crossings in the received signal,

b) calculation of zero crossing sequences of subsequences of the data symbol sequence with a model for frequency modulation with memory,

c) construction of a trellis diagram on the basis of the model for the frequency modulation with memory,

d) reconstruction of the transmitted data symbol sequence, wherein for each time (k+1)T_{b}(T_{b} symbol interval, k=0, 1, . . . ) and throughout the duration of a received subsequence:
d.1) those paths through the trellis diagram are excluded whose state with respect to the interval [kT_{b}, (k+1)T_{b}] corresponds to a number of calculated zero crossings, which number does not match the number of detected zero crossings of the received signal in the interval [kT_{b}, (k+1)T_{b}] and then

d.2) the branch metrics of the remaining paths are calculated and are added to the respective existing path metrics, wherein, when two paths meet one another at a node point in the trellis diagram, the path with the lower path metric is selected.

In the second selection step d.2), the method according to the invention thus uses the Viterbi algorithm which is known per se, in which a successive path metric calculation is carried out by addition of newly calculated branch metrics relating to previously existing path metrics. The efficiency achieved in this way is a necessary precondition for a practically and commercially (in the sense of a small chip area) worthwhile implementation of a sequence detection algorithm. This successive metric calculation limits the number of calculations in each symbol interval, and depends, inter alia, on the number of states in the trellis diagram. Furthermore, the use of the first metric and of the first selection step associated with it has the advantage that the paths which still potentially need to be considered are thinned out considerably with the progress through the trellis diagram. The more complex second metric need then be calculated by the second selection step only for these remaining paths.

In method step b), the hypothetical subsequences of the data symbol sequence that are formed have the model on which the trellis diagram is based for the frequency modulation with memory applied to them. This can advantageously be carried out by means of a filter which should be designed such that it at least approximately describes the signal generation in the transmitter. Convolution of an input variable with filter coefficients can be carried out in the filter, with an output variable thus being produced. The input side of the filter is thus fed with the hypothetical subsequences of the data symbol sequence, and convolutions of the data symbols {dₖ} with coefficient sequences {h_{i,k}} are carried out in the filter.

The filter may also be in the form of a linear state machine (Finite State Machine: FSM) in accordance with the American NIST (National Institute of Standards and Technology) terminology. For more details, reference should be made to the German Patent Application “Verfahren und Vorrichtung zur Berechnung von Nulldurchgangs-Referencezsequenzen für die Signal-detektion winkelmodulierter Signale auf der Basis von Nulldurchgängen des Empfangssignals” [Method and apparatus for calculation of zero crossing reference sequences for the signal detection of angle-modulated signals on the basis of zero crossings in the received signal] (Applicant Infineon Technologies AG), whose entirety disclosure content is included in the present application.

The modulation memory assumed in the model always has a defined length L. If a modulation memory of a length L≧2 is used at the transmitter end (in this case, these methods are also referred to as so-called partial response modulation methods, in which the spectral impulse function g(t) extends over two or more symbol intervals), the modulation memory is taken into account in linear form by means of the calculation model defined by the FSM. The modulation type, in particular the selected spectral impulse function g(t), influences the linear equation, which indicates the relationship between the state variables and the initial values of the FSM.

During the processing of the Viterbi algorithm, the so-called shortest path through the trellis diagram is determined recursively. Determination of this shortest path through the trellis diagram is the equivalent of the reconstruction of the data symbol sequence transmitted from the transmitter. Since, in the present case the model mentioned above is based on frequency modulation, the nodes in the trellis diagram represent the filter states. The nodes which are located vertically one above the other relate to the same symbol clock limit. This means that the states which are represented by the nodes in the horizontal direction differ by a discrete time, namely the symbol time duration, by means of which the symbol clock is determined.

It is assumed that the channel is distortion-free, so that the occurrence of intersymbol interference in the detection process is ignored. This assumption is realistic in the case of wire-free communications systems covering short distances such as Bluetooth, DECT etc.

Various metrics may be used for calculation of the branch metrics in the second selection step. For example, it is possible to use an interval metric such as a Euclidean interval metric, in which the Euclidean interval between the received zero crossing sequence and the theoretical zero crossing sequence is the governing factor. The branch which has the smallest Euclidean interval is selected, and the correspondingly calculated branch metric is added to the existing path metric.

The apparatus and the transmitter which is transmitting the frequency modulated signal are advantageously already synchronized when the apparatus carries out the steps which are required for demodulation. In particular, for this purpose, the apparatus and the transmitter have units for symbol synchronization.

The signal to be transmitted is preferably modulated at the transmitter end by means of the CPFSK (Continuous Phase Frequency Shift Keying) method.

The apparatus for carrying out the method according to the invention has a detector for zero crossings in the received signal. The apparatus furthermore has a sequence generator for formation of hypothetical subsequences of the data symbol sequence. In order to reconstruct the transmitted data symbol sequence, the apparatus contains a comparison and calculation unit for filtration of the subsequences which are supplied from the sequence generator, using the model for frequency modulation, for determination of hypothetical zero crossing sequences, corresponding to the filter subsequences, for comparison of the numbers of hypothetical and detected zero crossings, and for calculation of branch metrics of paths and for their addition to respectively existing path metrics following the previous exclusion of paths on the basis of the comparison of the numbers of zero crossings.

The detector for zero crossings in the received signal may be formed by a conventional limiter/discriminator apparatus.

### BRIEF DESCRIPTION OF THE DRAWINGS

The invention will be explained in more detail in the following text with reference to the drawings, in which:

FIG. 1 shows the method of operation of a detector for zero crossings;

FIG. 2 shows a schematic illustration of one exemplary embodiment of the apparatus according to the invention; and

FIGS. 3a, 3b show schematic illustrations of in each case one part of the states of the trellis diagram with the selection steps of trellis pruning (a) and trellis pursuit (b).

### DETAILED DESCRIPTION OF THE PREFERRED EMBODIMENTS

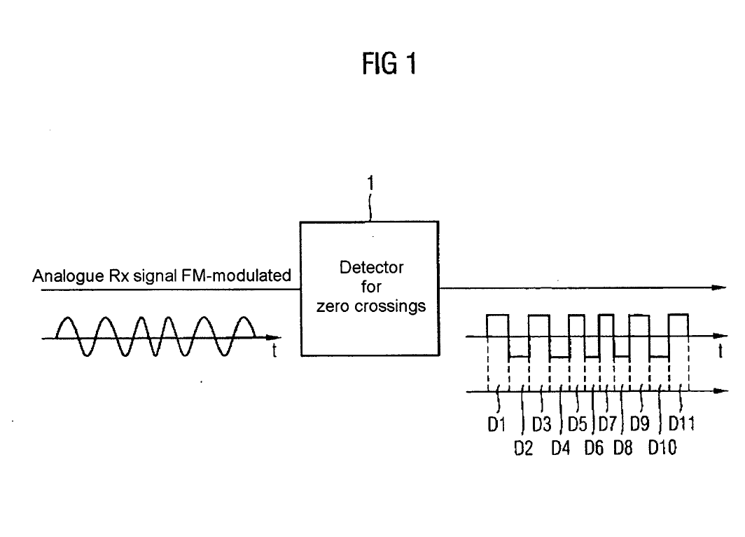

FIG. 1 illustrates how an analogue received signal which is, for example, in the intermediate frequency band is converted by means of a zero crossing detector 1 to a square-wave signal whose zero crossings can be evaluated. The number of zero crossings in each symbol interval (or a section of the symbol interval) can be detected, and can be used for the method according to the invention. The zero crossing detector 1 may be formed by a limiter/discriminator apparatus, or may contain an apparatus such as this.

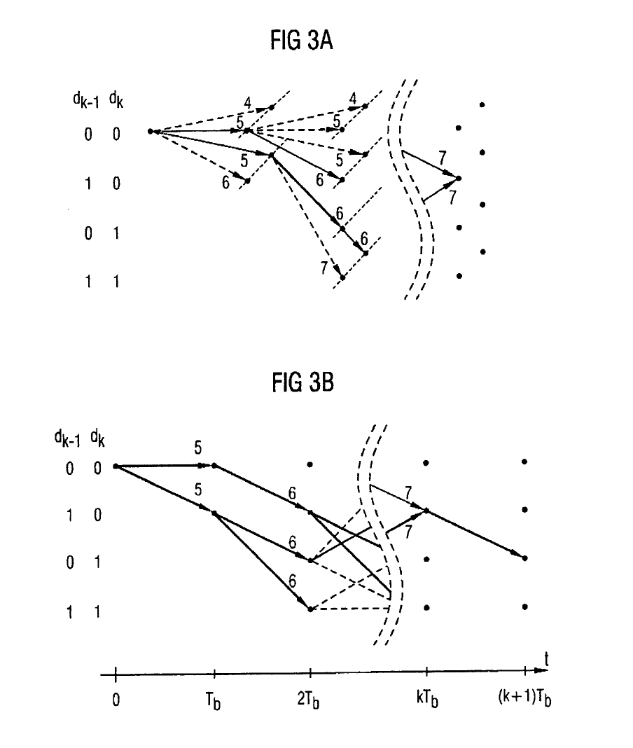

The method according to the invention is illustrated schematically in FIG. 3. The number of zero crossings, which depends on the respectively transmitted symbol sequence, is mapped in an extended, three-dimensional trellis diagram. The trellis diagram was constructed on the basis of an assumption of the frequency modulation, with memory, in the transmitter.

A conventional trellis diagram has the two dimensions of time and potentially transmitted bits and trellis states as a state description (possibly with additional zero phase information). According to FIG. 3a, the potential number of zero crossings is now plotted as an additional state component in the third dimension on the trellis diagram. The numerical comparison of the zero crossings between the received subsequence and potential possible received subsequences is then used to reduce the third dimension in each time step (trellis pruning). The potentially possible received subsequences are calculated by application of a channel model to all the potentially possible transmitted subsequences.

Starting from the defined initial state at the time t=0, the zero crossings in the signal received in the interval [0, T_{b}] are counted. Since only a finite number of zero crossings can exist in this interval (in FIG. 3, these are four or five zero crossings for dₖ₊₁=0 and five or six zero crossings for dₖ₊₁=1) the only paths which are retained in the first selection step are those which satisfy this requirement. This path selection is also referred to as trellis pruning.

The first selection step results in the conventional two-dimensional trellis diagram illustrated in FIG. 3b. The second selection step is carried out in the same time step by calculation of a second metric as in the case of the standard Viterbi algorithm, and can be referred to as trellis pursuit. This second selection step comprises the calculation of the new branch metric for each still existing path, which is added to the previous path metric. The two selection steps are in this way carried out successively in each of the successive time steps, that is to say the first selection step is carried out again in the next time step, in which further paths are excluded, with the new path metrics being calculated for the remaining paths in the second selection step. During the course of the selection process, two paths meet one another at some time at a node point in the two-dimensional trellis diagram (in FIG. 3b for t=kT_{b}). In a situation such as this, the path which is selected is that which has the lower path metric.

In FIG. 3a, all of the paths which have survived the first selection step are identified by solid arrows, while the paths which have been sorted out are identified by dashed arrows. In FIG. 3b, the paths which are continued after the calculation of the second metric and, possibly, the application of a second selection step (two paths meeting one another at a node), are illustrated as the thicker arrows. The example in FIGS. 3a, b has been based on the assumption of a modulation-inherent memory of one symbol duration.

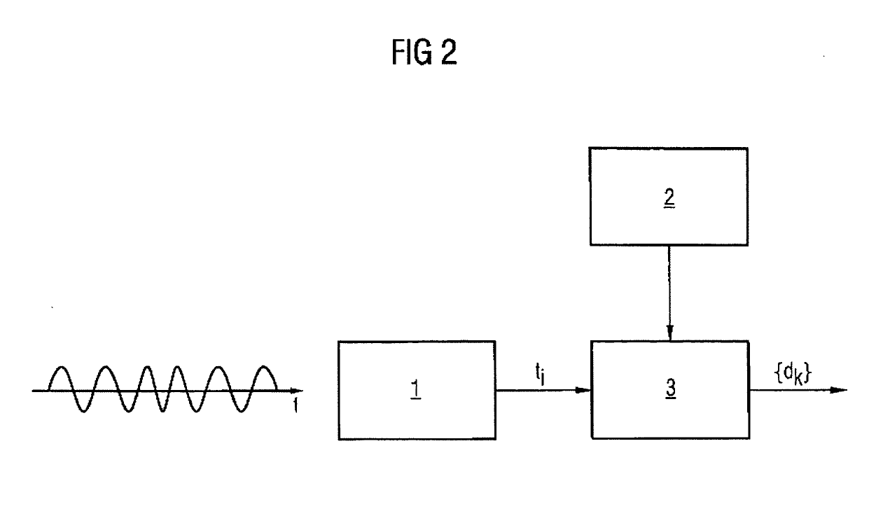

By way of example and schematically, FIG. 2 shows an apparatus for carrying out the method. In this case, the zero crossing detector 1 passes the time ti of the detected zero crossings to the comparison and calculation unit 3, which receives a number of potentially possible transmitted subsequences of the data symbols from a sequence generator 2. The subsequences supplied from the sequence generator 2 are filtered in the comparison and calculation unit 3 on the basis of the model for the frequency modulation with memory. The way in which the various potential possible transmitted subsequences are changed by the modulation memory are thus calculated in advance, as well as the influence of this on the zero crossing sequences. Hypothetical zero crossing sequences are thus calculated in the comparison and calculation unit 3. Furthermore the trellis diagram is constructed in the comparison and calculation unit 3, on the basis of the model. Those paths in which the number of calculated zero crossings does not match the number of detected zero crossings are now eliminated in the first selection step in each time step. In the second selection step, which follows this, the comparison and calculation unit 3 calculates the branch metrics of the surviving paths, and adds these to the existing path metrics of the corresponding paths. After processing the scheme for the duration of one subsequence, the comparison and calculation unit 3 outputs the data symbol sequence {dₖ} corresponding to the surviving path.

The described two-stage decision process with the two metrics which differ from one another thus makes it possible to implement an efficient maximum likelihood sequence detection method based on the known Viterbi algorithm. The performance of the method according to the invention may, for example, be assessed by a bit error SNR (signal-to-noise power ratio) curve, and virtually reaches the optimality provided by maximum likelihood sequence detection (in accordance with DE 102 37 867.3). The described method thus allows the use of an intermediate frequency receiver, which is generally low in cost and is not complex, and has a limiting output in conjunction with very powerful and efficient digital receiver concepts.

By way of example, the method according to the invention can be applied to CPFSK signals (Continuous Phase Frequency Shift Keying), as are used in communication methods such as DECT or Bluetooth.

1. A method for demodulation of an analogue received signal which is digitally frequency modulated at the transmitter end with a data symbol sequence, comprising the steps of:
a) detecting zero crossings in the received signal,
b) calculating zero crossing sequences of subsequences of the data symbol sequence with a model for frequency modulation with memory,
c) constructing a trellis diagram on the basis of the model for the frequency modulation with memory,
d) reconstructing the transmitted data symbol sequence, wherein for each time and throughout the duration of a received subsequence:
d.1) those paths through the trellis diagram are excluded whose state with respect to an interval corresponds to a number of hypothetical zero crossings, which number does not match the number of detected zero crossings of the received signal in the interval and then
d.2) the branch metrics of the remaining paths are calculated and are added to the respective existing path metrics, wherein, when two paths meet one another at a node point in the trellis diagram, the path with the lower path metric is selected.

2. The method according to claim 1, wherein
in method step b), data symbols from the hypothetical subsequences are fed into a filter, in which the zero crossing sequences are calculated on the basis of the model.

3. The method according to claim 2, wherein the filter is a linear state machine.

4. The method according to claim 1, wherein
before carrying out the method steps, the transmitter which is transmitting the frequency-modulated signal and the receiver which is receiving the frequency-modulated signal are synchronized to one another.

5. The method according to claim 1, wherein
the frequency-modulated received signal is a Continuous Phase Frequency Shift Keying signal (CPFSK).

6. An apparatus for demodulation of an analogue received signal which is digitally frequency modulated at the transmitter end with a data symbol sequence, comprising:
a detector for detecting zero crossings in the received signal,
a sequence detector for the formation of hypothetical subsequences of the data symbol sequence, and
a comparison and calculation unit for calculation of zero crossing sequences corresponding to the model of a frequency modulation group with memory, for comparison of the numbers of calculated and detected zero crossings, and for calculation of branch metrics of paths, and for their addition to respective existing path metrics once paths have previously been excluded on the basis of the comparison of the numbers of zero crossings.

7. The apparatus according to claim 6, wherein
the comparison and calculation unit comprises a filter for calculation of the zero crossing sequences on the basis of the model.

8. The apparatus according to claim 7, wherein
the filter is a linear state machine.

9. The apparatus according to claim 6, wherein
the zero crossing detector is formed by a limiter/discriminator apparatus, or contains such an apparatus.

10. The apparatus according to claim 6, wherein the apparatus is designed for Continuous Phase Frequency Shift Keying signals (CPFSK).

11. A cordless digital communications system which is based, in particular, on the Bluetooth or DECT or WDCT Standard comprising an apparatus for demodulation of an analogue received signal which is digitally frequency modulated at the transmitter end with a data symbol sequence, comprising:
a detector for detecting zero crossings in the received signal,
a sequence detector for the formation of hypothetical subsequences of the data symbol sequence, and
a comparison and calculation unit for calculation of zero crossing sequences corresponding to the model of a frequency modulation group with memory, for comparison of the numbers of calculated and detected zero crossings, and for calculation of branch metrics of paths, and for their addition to respective existing path metrics once paths have previously been excluded on the basis of the comparison of the numbers of zero crossings.

12. The cordless digital communication system according to claim 11, wherein
the comparison and calculation unit comprises a filter for calculation of the zero crossing sequences on the basis of the model.

13. The cordless digital communication system according to claim 12, wherein
the filter is a linear state machine.

14. The cordless digital communication system according to claim 11, wherein
the zero crossing detector is formed by a limiter/discriminator apparatus, or contains such an apparatus.

15. The cordless digital communication system according to claim 11, wherein the apparatus is designed for Continuous Phase Frequency Shift Keying signals (CPFSK).
